(19) United States
(12) Patent Application Publication
(10) Pub. No.: US 2015/0293607 A1
(43) Pub. Date: Oct. 15, 2015

(54) CHORD INPUT METHOD OF HANDHELD DEVICE MATCHING WITH VIRTUAL INTERFACE AND PHYSICAL BUTTONS AND HANDHELD DEVICE USING THE SAME

(71) Applicant: NATIONAL CHENG KUNG UNIVERSITY, Tainan City (TW)

(72) Inventors: Fong-Gong WU, Tainan City (TW); Yu-Chun HUANG, Tainan City (TW); Meng-Long WU, Tainan City (TW)

(73) Assignee: NATIONAL CHENG KUNG UNIVERSITY, Tainan City (TW)

(21) Appl. No.: 14/252,892

(22) Filed: Apr. 15, 2014

(51) Int. Cl. G06F 3/023; G06F 3/041; G06F 3/0488; G06F 3/02

(52) U.S. Cl. CPC G06F 3/0235; G06F 3/021; G06F 3/041; G06F 3/04886

(57) ABSTRACT

A handheld device matching with a virtual interface and physical buttons contains a handheld body including a touch screen, a control module and a plurality of buttons. The touch screen and the plurality of buttons are electrically connected with the control module, and the touch screen displays a virtual interface and a display frame, the virtual interface has a plurality of virtual keys, and each of the virtual keys has a plurality of characters arranged in an order corresponding to an arrangement of the plurality of buttons. When one of the virtual keys and one of the buttons are selected, one of the characters which corresponds to the selected virtual key and the selected button is displayed in the display frame. In addition, a chord input method matching with a virtual interface and physical buttons is applicable for the handheld device.

### FIELD OF THE INVENTION

The present invention relates to a chord input method of handheld device matching with a virtual interface and physical buttons and a handheld device using the same, especially to, a handheld device of which each virtual key has a plurality of characters arranged in an order corresponding to an arrangement of a plurality of buttons.

### BACKGROUND OF THE INVENTION

Conventional physical buttons for inputting letters/texts to a mobile device is replaced by virtual touch screen currently. However, the mobile device (such as a smart phone) is provided with a conventional QWERTY keyboard having a small size, so it is difficult for a user to select desired letters accurately by ways of the QWERTY keyboard, thus increasing input errors.

Taiwan Publication No. 200705239, entitled “Method and Device of Inputting Letters to Tablet Computer” has disclosed a chord keyboard, a stylus, a control circuit, and a connecting end which is in connection with a tablet computer. The chord keyboard is arranged on an upper right corner of the tablet computer, and a plurality of touch buttons are configured on the touch screen so as to cooperate with the chord keyboard, thereby replacing conventional standard keyboard, inputting letters easily, and lowering weight of the tablet computer.

However, such conventional method and device have shortcomings as follows:

1. The user has to input letters by using the stylus, thus increasing operation cost.

2. The conventional method and device are merely applied in the tablet computer.

The present invention has arisen to mitigate and/or obviate the afore-described disadvantages.

### SUMMARY OF THE INVENTION

The primary object of the present invention is to provide a handhold device of which a virtual interface matches with a plurality of buttons to facilitate selection and inputting of letters.

Another object of the present invention is to enable a user to touch the touch screen by the user's hand to select desired letters immediately and lower operation cost, or by a stylus to select desired letters precisely.

Another object of the present invention is to provide a chord input method by which a letter can be displayed via pressing a button and touching a virtual interface displayed on the touch screen.

Another object of the present invention is to reduce input errors and enhance inputting speed.

Another object of the present invention is to save the learning time for the user.

To obtain the above objects, the present invention provides a handheld device matching with a virtual interface and physical buttons. The hand held device contains a handheld body, which includes a touch screen, a control module and a plurality of buttons. The touch screen and the plurality of buttons are electrically connected with the control module. The touch screen displays a virtual interface and a display frame. The virtual interface has a plurality of virtual keys. Each of the plurality of virtual keys has a plurality of characters arranged in an order corresponding to an arrangement of the plurality of buttons, such that when one of the virtual keys and one of the buttons are selected, one of the characters which corresponds to the selected virtual key and the selected button is displayed in the display frame.

Preferably, the handheld body is any one of a tablet computer, a smart phone, and a handheld personal digital assistant.

Preferably, a number of the plurality of buttons is five, and the five buttons are arranged on a first side of the handheld body.

Preferably, a number of the plurality of buttons is six, and five of the plurality of buttons are arranged on a first side of the handheld body, one of the plurality of buttons is arranged on a second side of the handheld body opposite to the first side of the handheld body.

Preferably, the virtual interface displayed on the touch screen has a first virtual key, a second virtual key, a third virtual key, a fourth virtual key, a fifth virtual key, and a sixth virtual key. The first virtual key has a plurality of characters, and the plurality of characters of the first virtual key are letter Q, letter W, letter E, letter R, and letter T. The second virtual key has a plurality of characters, and the plurality of characters of the second virtual key are letter Y, letter U, letter I, letter O, and letter P. The third virtual key has a plurality of characters, and the plurality of characters of the third virtual key are letter A. letter S, letter D, letter F, and letter G. The fourth virtual key has a plurality of characters, and the plurality of characters of the fourth virtual key are letter H, letter J, letter K, and letter L. The fifth virtual key has a plurality of characters, and the plurality of characters of the fifth virtual key are letter Z, letter X, letter C, and letter V. The sixth virtual key has a plurality of characters, and the plurality of characters of the sixth virtual key are letter B, letter N, and letter M.

Preferably, the virtual interface displayed on the touch screen further has a seventh virtual key, and the seventh virtual key has a character, the character of the seventh virtual key is a space character.

The present invention also provides a chord input method of a handheld device matching with a virtual interface and physical buttons. The handheld device contains a touch screen, a control module, and a plurality of buttons, wherein the touch screen and the plurality of buttons are electrically connected with the control module. The chord input method comprises steps of: displaying a virtual interface and a display frame on the touch screen, wherein the virtual interface has a plurality of virtual keys, and each of the plurality of virtual keys has a plurality of characters arranged sequentially; arranging the plurality of characters of a respective one of the virtual keys in an order corresponding to an arrangement of the plurality of buttons; enabling a user to select one of the plurality of virtual keys from the virtual interface displayed on the touch screen and to select one of the plurality of buttons so that one of the plurality of characters which corresponds to the selected virtual key and the selected button is selected; and displaying the selected character in the display frame.

Preferably, the virtual interface displayed on the touch screen has a first virtual key, a second virtual key, a third virtual key, a fourth virtual key, a fifth virtual key, and a sixth virtual key. The first virtual key has a plurality of characters, and the plurality of characters of the first virtual key are letter Q, letter W, letter E, letter R, and letter T. The second virtual key has a plurality of characters, and the plurality of characters of the second virtual key are letter Y, letter U, letter I, letter O, and letter P. The third virtual key has a plurality of characters, and the plurality of characters of the third virtual key are letter A, letter S, letter D, letter F, and letter G. The fourth virtual key has a plurality of characters, and the plurality of characters of the fourth virtual key are letter H, letter J, letter K, and letter L. The fifth virtual key has a plurality of characters, and the plurality of characters of the fifth virtual key are letter Z, letter X, letter C, and letter V. The sixth virtual key has a plurality of characters, and the plurality of characters of the sixth virtual key are letter B, letter N, and letter M.

Preferably, the step of enabling a user to select one of the plurality of virtual keys from the virtual interface displayed on the touch screen and to select one of the plurality of buttons further comprises the step of enabling a user to touch one of the plurality of virtual keys firstly and then to press one of the plurality of buttons such that one of the characters, which corresponds to the pressed button, of the touched virtual key is displayed in the display frame.

Preferably, the step of enabling a user to select one of the plurality of virtual keys from the virtual interface and to select one of the plurality of buttons further comprises the step of enabling a user to press one of the plurality buttons firstly and then to touch one of the plurality virtual keys such that one of the characters, which corresponds to the pressed button, of the touched virtual key is displayed in the display frame.

### BRIEF DESCRIPTION OF THE DRAWINGS

FIG. 1 is a plan view of a handheld device according to a preferred embodiment of the present invention.

FIG. 2 is a flow chart of a chord input method of a handheld device according to a preferred embodiment of the present invention.

FIG. 3 is a plan view showing the operation of the handheld device according to the preferred embodiment of the present invention.

FIG. 4 is another plan view showing the operation of the handheld device according to the preferred embodiment of the present invention.

FIG. 5 is another plan view showing the operation of the handheld device according to the preferred embodiment of the present invention.

FIG. 6 is still another plan view showing the operation of the handheld device according to the preferred embodiment of the present invention.

FIG. 7 is still another plan view showing the operation of the handheld device according to the preferred embodiment of the present invention.

FIG. 8 is also another plan view showing the operation of the handheld device according to the preferred embodiment of the present invention.

FIG. 9 is also another plan view showing the operation of the handheld device according to the preferred embodiment of the present invention.

FIG. 10 is a comparison chart between a learning performance of the chord input method of the present invention and that of conventional input methods.

### DETAILED DESCRIPTION OF THE PREFERRED EMBODIMENTS

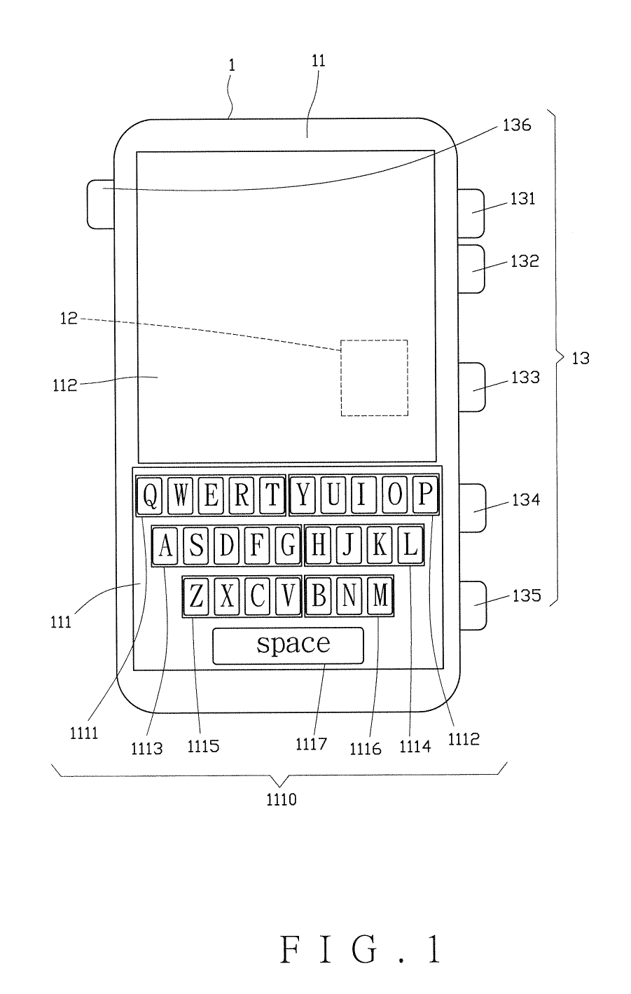

With reference to FIG. 1, a handheld device matching with a virtual interface and physical buttons according to a preferred embodiment of the present invention comprises:

a handheld body 1 including a touch screen 11, a control module 12 and a plurality of buttons 13, wherein the touch screen 11 and the plurality of buttons 13 are electrically connected with the control module 12, and the touch screen 11 displays a virtual interface 111 and a display frame 112, the virtual interface 111 has a plurality of virtual keys 1110, and each of the plurality virtual keys 1110 has a plurality of characters arranged sequentially. Specifically, the plurality of characters of a respective one of the plurality virtual keys 1110 are arranged in an order corresponding to an arrangement of the plurality of buttons 13, and when one of the plurality of virtual keys 1110 and one of the plurality of buttons 13 are selected, one of the plurality of characters which corresponds to the selected virtual key 1110 and the selected button 13 is displayed in the display frame 112. In this embodiment, the virtual interface 111 has a first virtual key 1111, a second virtual key 1112, a third virtual key 1113, a fourth virtual key 1114, a fifth virtual key 1115, a sixth virtual key 1116, and a seventh virtual key 1117. The first virtual key 1111 has a plurality of characters, and the plurality of characters of the first virtual key 1111 are letter Q, letter W, letter E, letter R, and letter T; the second virtual key 1112 has a plurality of characters, and the plurality of characters of the second virtual key 1112 are letter Y, letter U, letter I, letter O, and letter P; the third virtual key 1113 has a plurality of characters, and the plurality of characters of the third virtual key 1113 are letter A, letter S, letter D, letter F, and letter G; the fourth virtual key 1114 has a plurality of characters, and the plurality of characters of the fourth virtual key 1114 are letter H, letter J, letter K, and letter L; the fifth virtual key 1115 has a plurality of characters, and the plurality of characters of the fifth virtual key 1115 are letter Z, letter X, letter C, and letter V; the sixth virtual key 1116 has a plurality of characters, and the plurality of characters of the sixth virtual key 1116 are letter B, letter N, and letter M; the seventh virtual key 1117 has an character, and the character of the seventh virtual key 1117 is a space character. Furthermore, the plurality of buttons 13 are a first button 131, a second button 132, a third button 133, a fourth button 134, a fifth button 135, which are located on a first side of the handheld body 1. The first button 131 is near the second button 132 so that the first button 131 and the second button 132 are pressed by, for example, a user's forefinger easily. Preferably, a sixth button 136 is further located on a second side of the handheld body 1 opposite to the first side of the handheld body 1 so as to be pressed by, for example, the user's thumb, thus inputting the space character easily.

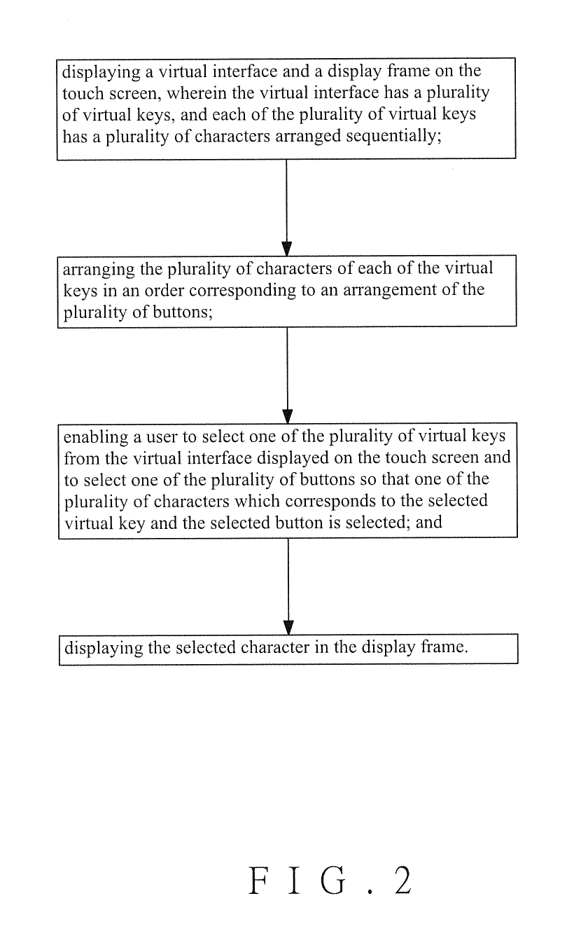

Furthermore, referring to FIGS. 1 and 2, the present invention also provides a chord input method of a handheld device matching with a virtual interface and physical buttons. In one embodiment, the handheld device comprises a handheld body 1, a touch screen 11, a control module 12, and a plurality of buttons 13, wherein the touch screen 11 and the plurality of buttons 13 are electrically connected with the control module 12, and the chord input method comprises steps of: displaying a virtual interface 111 and a display frame 112 on the touch screen 11, wherein the virtual interface 111 has a plurality of virtual keys 1110, and each of the plurality of virtual keys 1110 has a plurality of characters arranged sequentially; arranging the plurality of characters of a respective one of the virtual keys 1110 in an order corresponding to an arrangement of the plurality of buttons 13; enabling a user to select one of the plurality of virtual keys 1110 from the virtual interface 111 displayed on the touch screen 11 and to select one of the plurality of buttons 13 so that one of the plurality of characters which corresponds to the selected virtual key 1110 and the selected button 13 is selected; and displaying the selected character in the display frame 112.

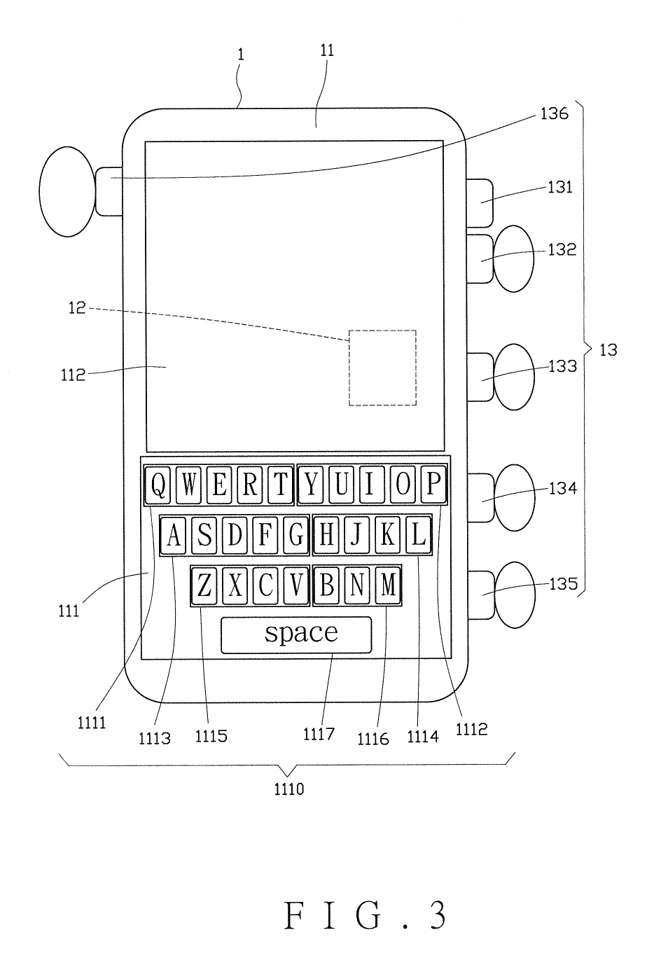

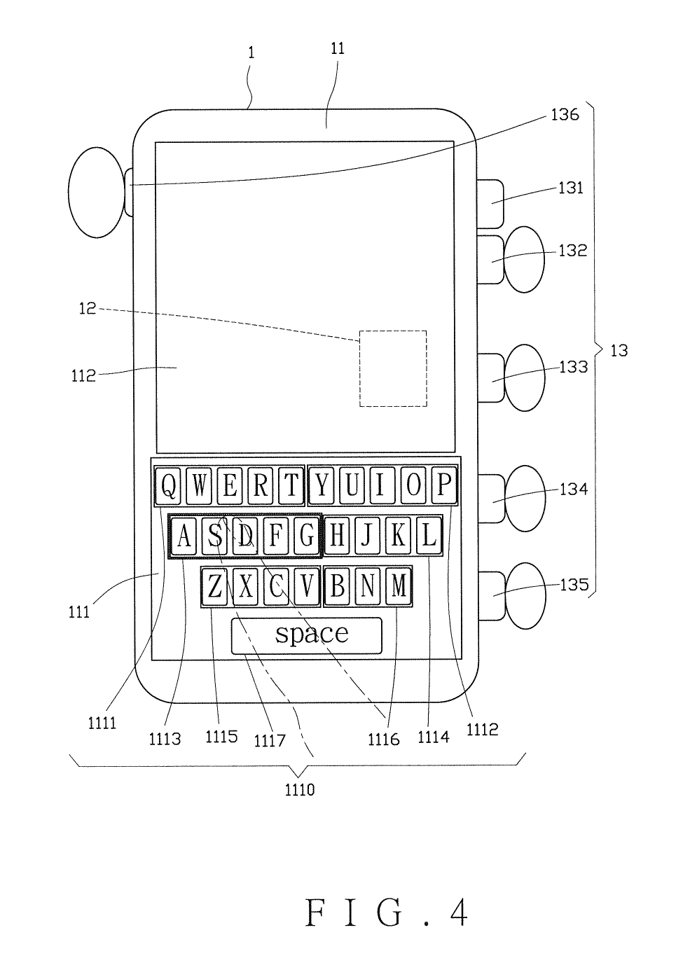

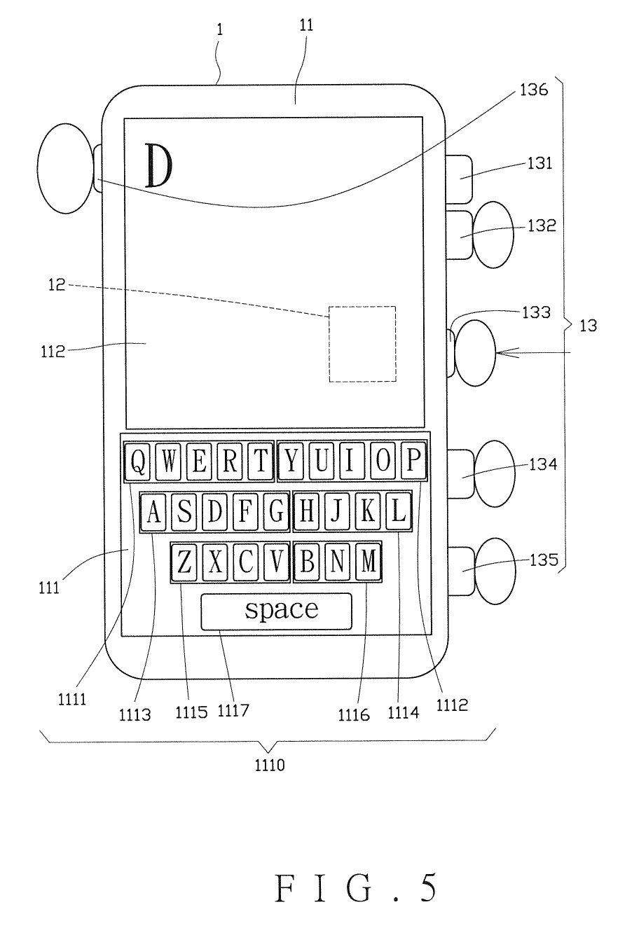

When in use, referring to FIGS. 3 to 5, the handheld body 1 can be held by one of the user's hand, such as left hand (as shown in FIG. 3), and wherein the handheld body 1 is any one of a tablet computer, a smart phone, and a handheld personal digital assistant. In this embodiment, the handheld body 1 is the smart phone, and fingers of user's left hand put on the plurality of buttons 13, for example, a forefinger of the user's left hand puts on the second button 132, a middle finger of the user's left hand puts on the third button 133, a ring finger of the user's left hand puts on the fourth button 134, a little finger of the user's left hand puts on the fifth button 135, and a thumb of the user's left hand puts on the sixth button 136, wherein the forefinger of the user's left hand is also capable of putting on the first button 131, hence the first button 131 and the second button 132 both can be pressed by the forefinger of the user's left hand. As desiring to input the letter D, the user can touch the touch screen 11 of the handheld body 1 by the other hand (i.e., right hand) or by a stylus to select the third virtual key 1113 firstly (wherein the third virtual key 1113 has the letter A, the letter S, the letter D, the letter F and the letter G) and then to press the third button 133 with the middle finger of his/her left hand, so that the letter D of the third virtual key 1113 is displayed in the display frame 112 (as illustrated in FIG. 5).

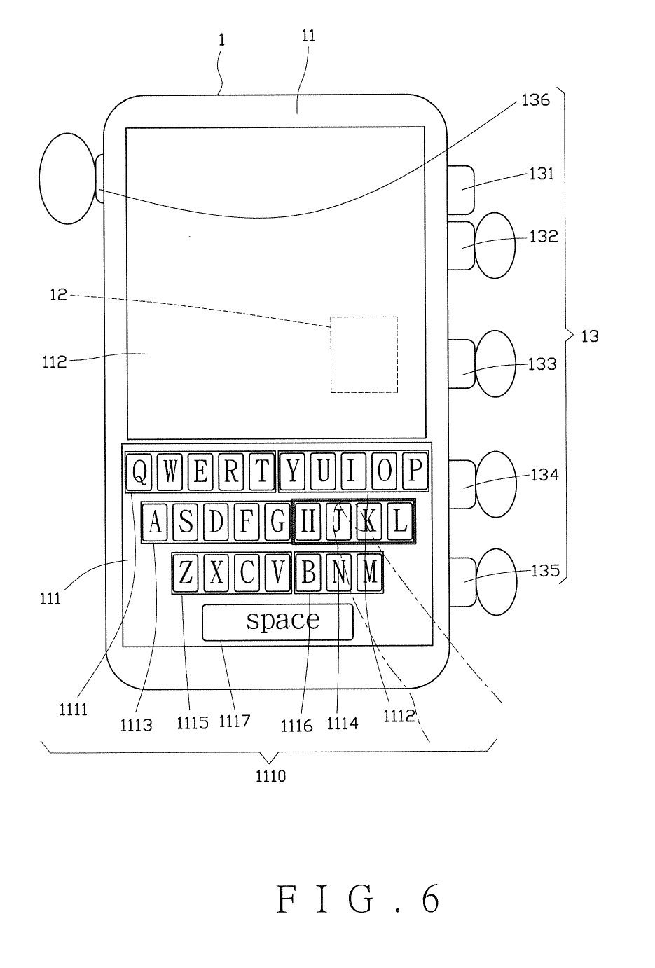

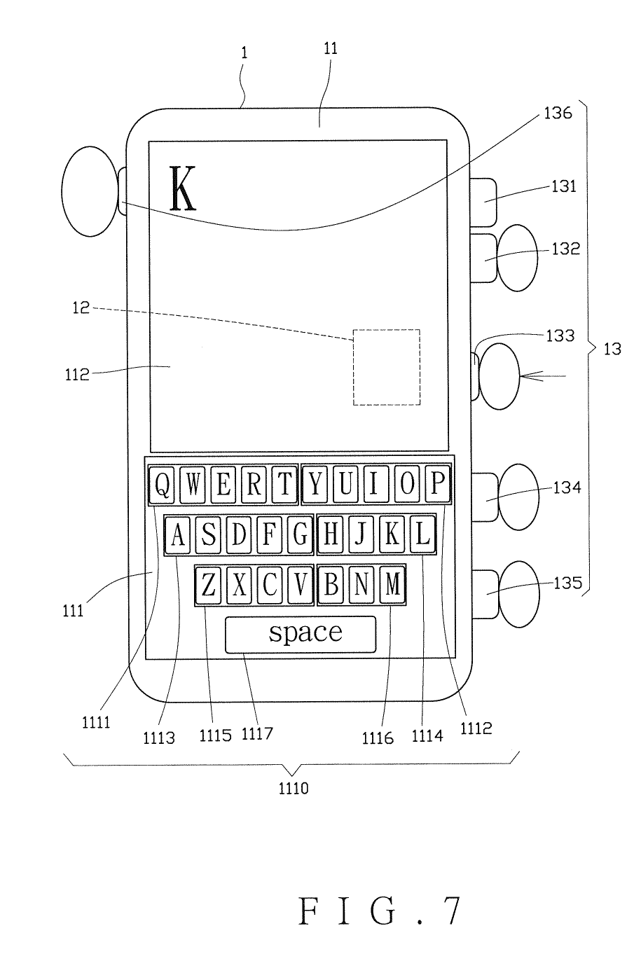

With reference to FIGS. 6 and 7, when the user holds the handheld body 1 with his/her left hand and intends to input the letter K, he/she can touch the touch screen 11 of the handheld body 1 by the other hand (i.e., right hand) or by a stylus to select the fourth virtual key 1114 firstly (wherein the fourth virtual key 1114 has the letter H, the letter J, the letter K, and the letter L) and then to press the third button 133 with the middle finger of his/her left hand, so that the letter K of the fourth virtual key 1114 is displayed in the display frame 112 (as illustrated in FIG. 7).

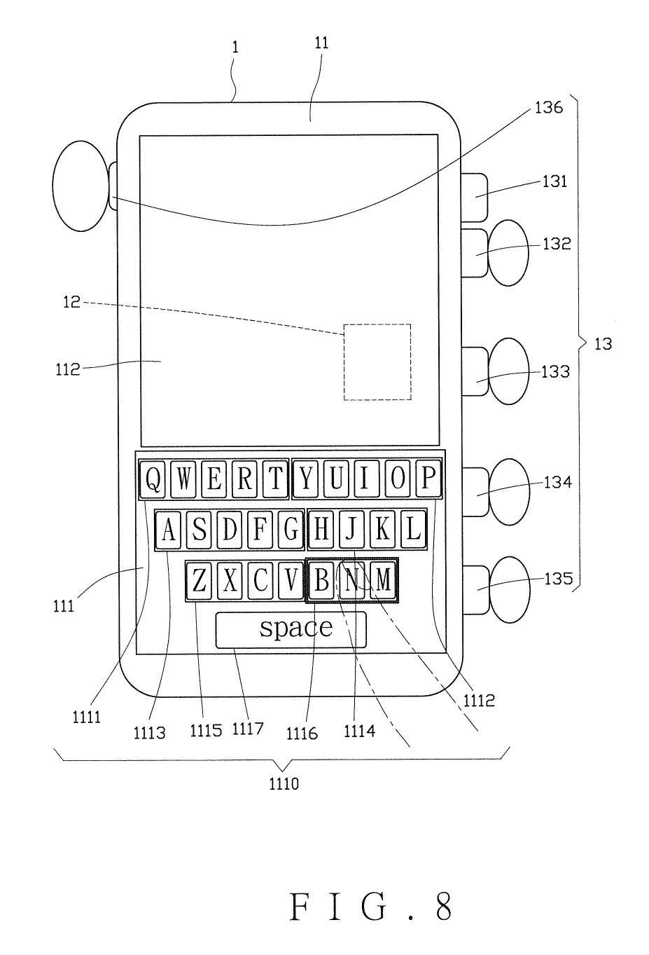

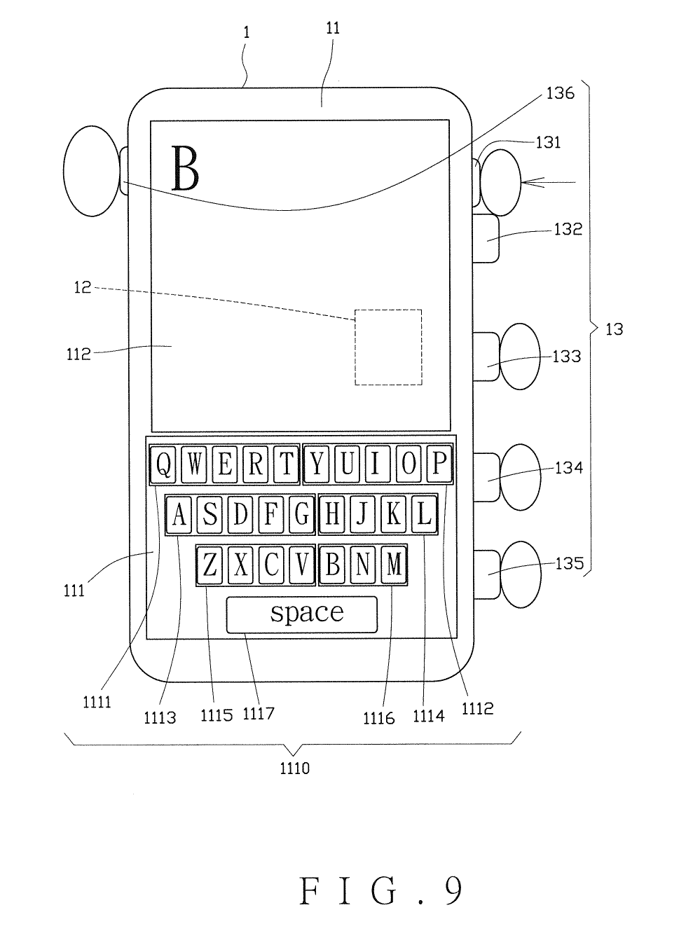

As illustrated in FIGS. 8 and 9, when the user holds the handheld body 1 with his/her left hand and is desired to input the letter B, he/she can touch the touch screen 11 of the handheld body 1 by the other hand (i.e., right hand) or by a stylus to select the sixth virtual key 1116 (wherein the sixth virtual key 1116 has the letter B, the letter N, and the letter M) and then to press the first button 131 with the forefinger of his/her left hand, so that the letter B of the sixth virtual key 1116 is displayed in the display frame 112 (as illustrated in FIG. 9).

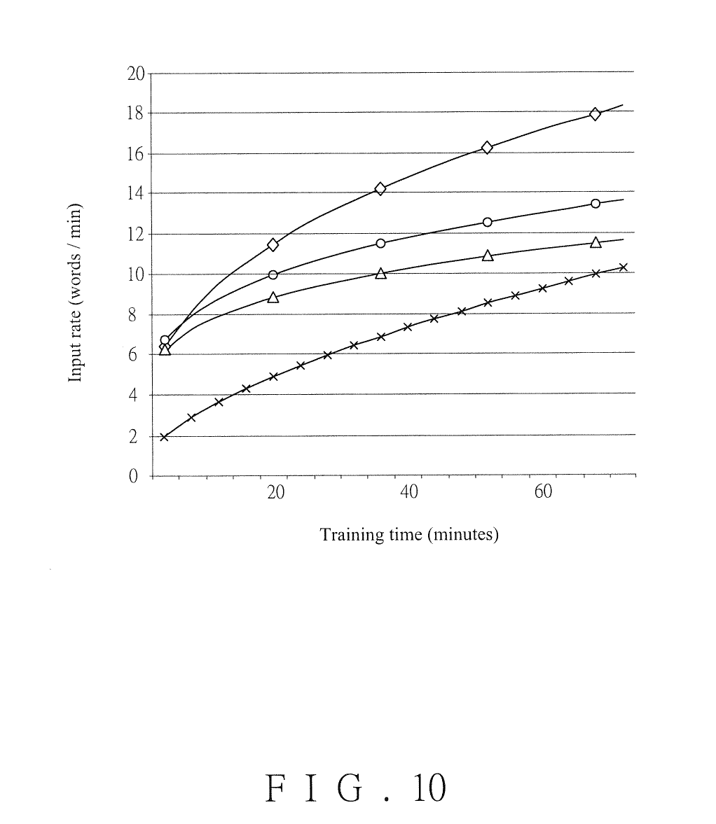

FIG. 10 is a comparison chart between a learning performance of the chord input method of the present invention and that of conventional input methods, wherein each curve line is calculated based on a learning curve formula, and the learning curve formula is derived on the basis of exponential regression curves to model the power law of practice. The learning curve formula is y=mx^{k}, wherein m represents a performance in an initial test, and k denotes learning efficiency (i.e., a camber of each curve line). An uppermost line in FIG. 10 implies the learning efficiency of the present invention, other lines, from the top to bottom, respectively means learning efficiencies of conventional input methods of ChordTap, TiltText and Twiddler. In details, the learning curve formula of the present invention is y=6.40x^{0.363}, the learning curve formula of ChordTap is y=8.41x^{0.241}, the learning curve formula of TiltText is y=7.68x^{0.213}, and the learning curve formula of Twiddler is y=4.90x^{0.578}. The input performance and learning efficiency of participants are measured in a test after the participants take some time to learn the input methods of the present invention and those of the conventional handheld devices. Compared with those of virtual keyboards of the conventional handheld devices, the chord input method of the present invention can reduce input errors and enhance inputting speed.

In the above described embodiment, the user touches one of the plurality of virtual keys 1110 firstly and then presses one of the plurality of buttons 13 to input and display a letter, corresponding to the pressed button 13, of the touched virtual key 1110 in the display frame 112. However, it is noted that if the user presses one of the plurality of buttons 13 firstly and then touches one of the plurality of virtual keys 1110, the letter, corresponding to the pressed button 13, of the touched virtual key 1110 also can be input and displayed in the display frame 112. For example, the letter E of the first virtual key 1111, the letter I of the second virtual key 1112, the letter D of the third virtual key 1113, the letter K of the fourth virtual key 1114, and the letter C of the fifth virtual key 1115 which correspond to the third button 133 can be input and displayed selectively after the third button 133 is pressed.

Furthermore, the first button 131, the second button 132, the third button 133, the fourth button 134, the fifth button 135 and the sixth button 136 are arranged on the first side of the handheld body 1, and the sixth button 136 is arranged on the second side of the handheld body 1 opposite to the first side of the handheld body 1 so that the user inputs any letter easily. But such an arrangement does not limit scope of the invention.

Moreover, the chord input method and the handheld device of the present invention also have the following advantages:

1. A general computer keyboard (QWERT keyboard) is used for the chord input method and the handheld device of the present invention, thus the arrangement of the virtual keys 1110 has been known well for ordinary people so that the needed time for learning the chord input method of the present invention is reduced. However, it is preferable that such an arrangement does not limit scope of the invention. In other words, other arrangements of the virtual keys 1110 are applicable for the handheld device of the present invention.

2. A plurality of characters are arranged in each of the first virtual key 1111, the second virtual key 1112, the third virtual key 1113, the fourth virtual key 1114 and the fifth virtual key 1115 of the virtual interface 111 so that the user views and selects desired letters clearly. However, in case only single letter is arranged on a respective one of the plurality of virtual keys 1110, a distance among the plurality of virtual keys 1110 is decreased, thereby accelerating inputting speed.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A handheld device comprising:
a handheld body including a touch screen, a control module and a plurality of buttons, the touch screen and the plurality of buttons electrically connected with the control module, the touch screen displaying a virtual interface and a display frame, the virtual interface having a plurality of virtual keys, wherein each of the plurality of virtual keys has a plurality of characters arranged in an order corresponding to an arrangement of the plurality of buttons, such that when one of the virtual keys and one of the buttons are selected, one of the characters which corresponds to the selected virtual key and the selected button is displayed in the display frame.

2. The handheld device as claimed in claim 1, wherein the handheld body is a tablet computer, a smart phone, or a handheld personal digital assistant.

3. The handheld device as claimed in claim 2, wherein a number of the plurality of buttons is five, and the five buttons are arranged on a first side of the handheld body.

4. The handheld device as claimed in claim 1, wherein a number of the plurality of buttons is six, and five of the plurality of buttons are arranged on a first side of the handheld body, one of the plurality of buttons is arranged on a second side of the handheld body opposite to the first side of the handheld body.

5. The handheld device as claimed in claim 1, wherein the virtual interface displayed on the touch screen has a first virtual key, a second virtual key, a third virtual key, a fourth virtual key, a fifth virtual key, and a sixth virtual key; the first virtual key has a plurality of characters, and the plurality of characters of the first virtual key are letter Q, letter W, letter E, letter R, and letter T; the second virtual key has a plurality of characters, and the plurality of characters of the second virtual key are letter Y, letter U, letter I, letter O, and letter P; the third virtual key has a plurality of characters, and the plurality of characters of the third virtual key are letter A, letter S, letter D, letter F, and letter G; the fourth virtual key has a plurality of characters, and the plurality of characters of the fourth virtual key are letter H, letter J, letter K, and letter L; the fifth virtual key has a plurality of characters, and the plurality of characters of the fifth virtual key are letter Z, letter X, letter C, and letter V; the sixth virtual key has a plurality of characters, and the plurality of characters of the sixth virtual key are letter B, letter N, and letter M.

6. The handheld device as claimed in claim 5, wherein the virtual interface displayed on the touch screen further has a seventh virtual key, and the seventh virtual key has a character, the character of the seventh virtual key is a space character.

7. A chord input method of a handheld device, the handheld device comprising a touch screen, a control module, and a plurality of buttons, wherein the touch screen and the plurality of buttons are electrically connected with the control module, and the chord input method comprising steps of:
displaying a virtual interface and a display frame on the touch screen, wherein the virtual interface has a plurality of virtual keys, and each of the plurality of virtual keys has a plurality of characters arranged sequentially;
arranging the plurality of characters of a respective one of the virtual keys in an order corresponding to an arrangement of the plurality of buttons;
enabling a user to select one of the plurality of virtual keys from the virtual interface displayed on the touch screen and to select one of the plurality of buttons so that one of the plurality of characters which corresponds to the selected virtual key and the selected button is selected; and
displaying the selected character in the display frame.

8. The chord input method as claimed in claim 7, wherein the virtual interface displayed on the touch screen has a first virtual key, a second virtual key, a third virtual key, a fourth virtual key, a fifth virtual key, and a sixth virtual key; the first virtual key has a plurality of characters, and the plurality of characters of the first virtual key are letter Q, letter W, letter E, letter R, and letter T; the second virtual key has a plurality of characters, and the plurality of characters of the second virtual key are letter Y, letter U, letter I, letter O, and letter P; the third virtual key has a plurality of characters, and the plurality of characters of the third virtual key are letter A, letter S, letter D, letter F, and letter G; the fourth virtual key has a plurality of characters, and the plurality of characters of the fourth virtual key are letter H, letter J, letter K, and letter L; the fifth virtual key has a plurality of characters, and the plurality of characters of the fifth virtual key are letter Z, letter X, letter C, and letter V; the sixth virtual key has a plurality of characters, and the plurality of characters of the sixth virtual key are letter B, letter N, and letter M.

9. The chord input method as claimed in claim 7, wherein the step of enabling a user to select one of the plurality of virtual keys from the virtual interface displayed on the touch screen and to select one of the plurality of buttons comprises the step of:
enabling a user to touch one of the plurality of virtual keys firstly and then to press one of the plurality of buttons such that one of the characters, which corresponds to the pressed button, of the touched virtual key is displayed in the display frame.

10. The chord input method as claimed in claim 7, wherein the step of enabling a user to select one of the plurality of virtual keys from the virtual interface displayed on the touch screen and to select one of the plurality of buttons comprises the step of:
enabling a user to press one of the plurality buttons firstly and then to touch one of the plurality virtual keys such that one of the characters, which corresponds to the pressed button, of the touched virtual key is displayed in the display frame.
